(19) United States
(12) Patent Application Publication
(10) Pub. No.: US 2025/0009101 A1
(43) Pub. Date: Jan. 9, 2025

(54) ELECTRICAL APPLIANCE

(71) Applicant: Dyson Technology Limited, Malmesbury, Wiltshire (GB)

(72) Inventor: Andrew John Dennis SPILLMAN, Bristol (GB)

(21) Appl. No.: 18/715,785

(22) PCT Filed: Nov. 18, 2022
(86) PCT No.: PCT/GB2022/052932

§ 371 Date: Jun. 3, 2024

(30) Foreign Application Priority Data
Dec. 3, 2021 (GB) 2117466.9

(51) Int. Cl. A45D 20/12; H01R 9/24; H01R 13/66

(52) U.S. Cl. CPC A45D 20/12; H01R 9/2475; H01R 13/66

(57) ABSTRACT

An electrical appliance comprising an electrical plug including a plug body and a removable plug terminal, wherein the plug terminal comprises an ID component configured to provide an ID data item. The appliance comprises a control system comprising an ID reader configured to read the ID component, wherein the control system is operable to configure at least one operational attribute of at least one electrical device of the electrical appliance in dependence on the ID data item. Beneficially, the electrical appliance of the invention is responsive to different plug terminals that may be attached to it and is able to configure various settings in accordance with the data item it reads from the plug terminal which ensures that the electrical appliance can adapt to various power schemes and regulations that may in place around the world, particularly if the ID data item is indicative of the country-suitability of the plug terminal.

### FIELD OF THE INVENTION

The invention relates generally to an electrical appliance, more particularly but not exclusively to a handheld appliance, that has functionality to configure internal settings of electronic devices in dependence on the territory in which it is being used.

### BACKGROUND

Electrical appliances are usually sold to consumers for use in a single country or region. However, different regions around the world may have different specific requirements for electrical safety and compliance standards. What is more, different regions also require different types of electrical plug having respective shape and pin configurations. Portable electrical appliances therefore need careful consideration before being taken on a trip to another country. Some electrical appliances may be designed to accommodate more than one operating voltage, and are usually known as ‘dual voltage’ devices, such they can be used in the US and the UK, for example. However, although such devices may be electrically compatible, they still require plug adapters to allow them to be used with suitable mains power sockets. Also, designing appliances to be adaptable to multiple different electrical power supplies incurs higher design and manufacturing costs.

These challenges become particularly acute with high power products such as hair dryers, curling tongs and so on which typically have power ratings exceeding 1000 W. Such products can be especially sensitive when being used in different territories when subjected to different power supplies.

### SUMMARY OF THE INVENTION

According to a first aspect of the invention, there is provided an electrical appliance comprising: an electrical plug comprising an ID component configured to provide an ID data item. The appliance comprises a control system comprising an ID reader configured to read the ID component, wherein the control system is operable to configure at least one operational attribute of at least one electrical device of the electrical appliance in dependence on the ID data item.

Beneficially, therefore, the electrical appliance of the invention is adapted to configure various settings in accordance with the data item it reads from the electrical plug terminal which ensures that the electrical appliance can adapt to various power schemes and regulations that may in place around the world, particularly if the ID data item is indicative of the country-suitability of the plug terminal.

In one embodiment of the invention, the electrical plug includes a plug body and a removable plug terminal. This is particularly useful, because the electrical appliance can be responsive to different plug terminal configurations that correspond to different territories or regions.

The plug body may be integrated into the main body of the electrical appliance. However, in other examples, the plug body may be positioned at the tail end of an electrical cable extending from the main body of the electrical appliance.

The ID component and the ID reader may take various forms. For example, the ID reader may be a vision-based system which is configured to recognise a visual marker or indicia of some type constituting the ID component. In other examples, the ID component may be a series of bumps or protrusions, similar to a Braille system, the configuration of which represents a data item. Similarly, the ID reader may include an array of microswitches configured to be responsive to the bump array to detect the ID data item.

In a particularly flexible example, the ID component is a data processing component such as an RFID transponder/tag which is configured to transmit the ID data item to the ID reader, which may be constituted by an RFID receiver. The ID component is configurable to store and transmit manufacturer-defined data to the ID reader so that the ID reader can instruct the electrical appliance the required power settings that are associated with the specific ID data item.

In one example, it is envisaged that the ID reader is located at the plug body. However, this is not essential, and it is envisaged that the ID reader could be located at other positions on the electrical appliance, for example on the main body. The position of the ID reader may depend on various factors. Positioning the ID reader on the plug body, close to the plug terminal, means that a relatively low power RFID tag may be used, for example a passive tag that is able to work at short transmission distances. So called ‘active’ RFID tags, having a self-contained power source rather than scavenging power from an RFID transceiver as is the case with a passive tag, have the capability of transmission over greater distances, which makes them appropriate for use in electrical appliances where a larger distance between the ID component and the ID reader is desirable.

The operational attributes that are configurable by the control system in response to reading the ID data item may be a voltage value, current value or power value of at least one of the electrical device in the electrical appliance. For example, in the case of the appliance being a hair dryer, the control system may set a different maximum voltage value, a maximum current value, and/or a maximum power value of a heater unit and/or a fan unit of the appliance. Therefore, the control system can limit the maximum power draw that the appliance can apply in dependence on the territory or geographical region in which it is being used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1 is a generalised view of a handheld electrical appliance in accordance with an example of the invention which is plugged into a wall outlet;

FIG. 2 is a schematic view of the electrical appliance shown in FIG. 1;

FIG. 3 shows a schematic view of another example of the invention.

In the drawings, the same reference numerals are used to denote features that are common across drawings.

### SPECIFIC DESCRIPTION

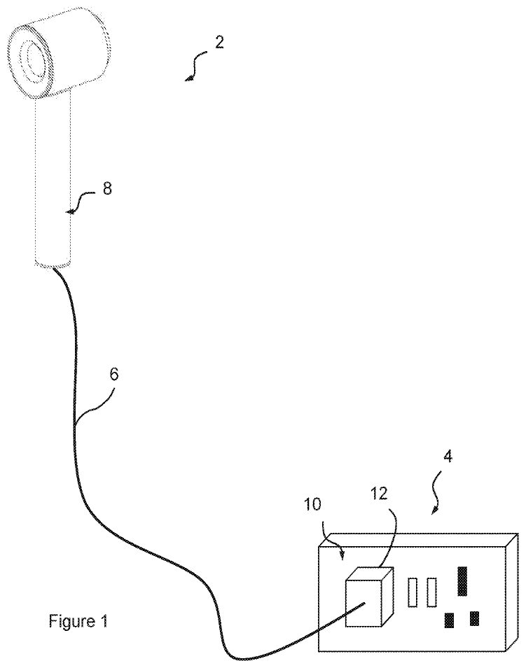

FIG. 1 shows a general arrangement to provide context for the invention. An electrical appliance 2 is connected to a wall box 4 of a mains power supply. The electrical appliance 2 includes an electrical supply cable 6 that extends from a main body 8 of the electrical appliance 2 and terminates in a plug 10 which is shown connected to the wall box 4 at a respective socket 12.

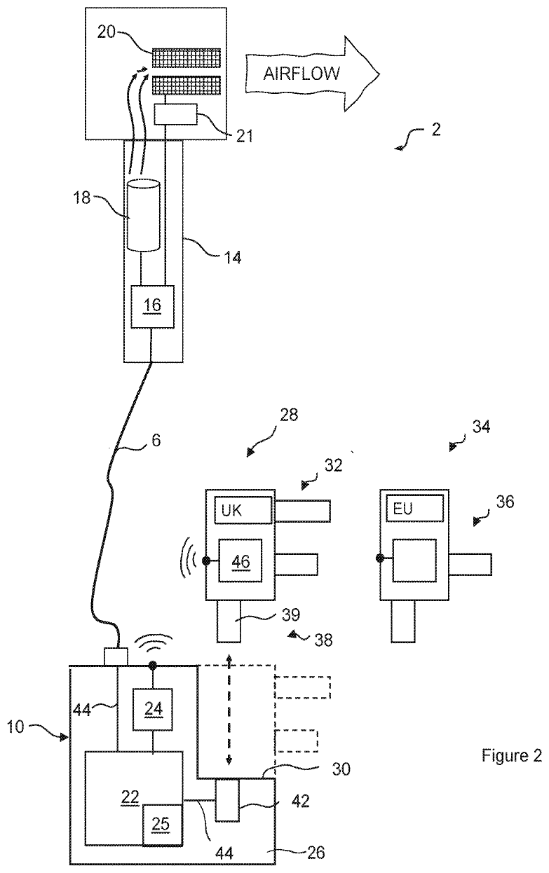

In this example of the invention, the electrical appliance 2 is a hair dryer, for example as is available from the applicant as the Dyson Supersonic® Hair Dryer. However, the electrical appliance of the invention is not limited to hair dryers and may be any appliance with internal electronic devices that can be reconfigured to change their power draw characteristics in dependence on the territory of use. As examples, the electrical appliance may also include fans, fan heaters, blown air styling brushes, curling tongs, and so on.

Whereas FIG. 1 shows a contextualised view of the electrical appliance 2, FIG. 2 provides a schematic overview and represents various electrical and electric elements of the electrical appliance 2.

As has been mentioned above, the electrical appliance 2 comprises the main body 8 and the plug 10 which are connected by the electrical cable 6. The cable 6 provides appropriate wiring for supplying power and for electronic data communication between the plug 10 and the main body 8. The main body 8 comprises an outer housing or casing 14 that accommodates several functional components of the electrical appliance 2. In overview, the functional components in the main body 8 comprise an appliance control module 16, a fan unit 18, a heater unit 20 and a heater control module 21.

The plug 10 also houses one or more functional components. As shown, these are a plug control module 22 and an ID reader 24. Optionally, a sensing module 25 may also be provided, as will be described in more detail later.

The body control module 16, the heater control module 21 and the plug control module 22 together provide control functionality for the electrical appliance 2 as will be explained in this description. That functionality may be partitioned between the different control modules as appropriate and, indeed, some partitioning is sometimes useful for various reasons. For example, it is convenient to have the heater control module 21 proximate to the heater unit 20 to reduce wire lengths, to surface mount sensors and so on. However, the partitioning shown and explained here is only exemplary, and it should be understood that the functionality described here may be provided by any control module.

It should also be appreciated that since the Figures are schematic, certain structures and elements are not shown here for the sake of brevity. For example, each of the control modules, and fan unit and the heater unit may contain appropriate printed circuit boards, connectors, wires, and other components which would be well understood by the skilled person and within their capabilities to configure appropriately.

Returning to FIG. 2, the plug 10 comprises two components: a plug chassis or body 26 and a plug terminal 28. The plug terminal 28 is removable from the plug body 26. In this embodiment, the plug body 26 and the plug terminal 28 are shaped in a complementary way. As shown, the plug body 26 includes a recess 30 which is shaped to receive a part of the plug terminal 28 so as to result in a clean aesthetic. It should be noted, however, that complementary shaping is not essential.

The removability of the plug terminal 28 from the plug body 26 means that the plug body 26 is configured to accept a plurality of different types of plug terminals 28, as will become apparent. In the illustrated embodiment, the plug terminal 28 is identified by the marking ‘UK’ and so is considered suitable for being used by domestic power outlets or wall sockets in the United Kingdom. As such, it has the typical 3-pin format 32 that will be familiar to persons in the UK. As the skilled person would appreciate, this format is known as Plug Type G in accordance with the worldwide plug standard. A second plug terminal 34 is also shown, and is identified by the marking ‘EU’. Therefore, the second plug terminal 34 has the EU-standard 2-pin format 36 as will be familiar to users in European countries, and as is also known as Plug Type C.

The plug terminal 28 and the plug body 26 connect together at an electrical coupling 38. Here, that coupling 34 is defined by a connector or pin 39 provided on the plug terminal 28 and a receiver or socket 42 provided on the plug body 26. The plug terminal 28 may therefore be connected to the plug body 26 by inserting the connector 39 into the socket 42, therefore uniting the plug body 26 and the plug terminal 28 in a single component. Suitable detent or locking systems may be provided in order to ensure the connection between the two components is secure, although these aspects are omitted here for brevity. Furthermore, suitable wiring 44 is provided in the plug to provide power and data transfer between the plug terminal 28, the socket 42, the plug control module 22 and the cable 6.

As is shown, the plug body 26 is a separate component to the main body 10 of the electrical appliance 2. This is by virtue of the specific embodiment being a hair dryer, such that it is customary to have a plug on the tail end of the cable. However, in other embodiments the plug body 26 may be provided as an integral component in the main body 10.

Usefully, therefore, the electrical appliance 2 has the capability to use a different configuration of plug terminal depending on where it is used. This is an advantage for the user if the electrical appliance 2 is used as a travel product. Beneficially, however, the electrical appliance 2 has the functionality to adjust operational settings or attributes depending on identification data provided by the plug terminal, which may indicate what specific plug type is used. For example, in territories with 240V 50 Hz AC mains networks, for example the UK, the electrical appliance 2 may apply certain operational settings to the fan unit 18 and the heater unit 20 to allow a predetermined power draw through the system. However, in territories which have a lower mains voltage, for example the US with 120V 60 Hz AC, the electrical appliance 2 may adjust the power applied to the fan unit 18 and the heater unit 20 to limit current draw. Another factor is the current rating of plugs that are used in different territories. Limiting the power draw of the appliance is therefore an advantage as it protects plugs with somewhat lower power rating from overheating.

To this end, the electrical appliance 2 is provided with the facility to identify data relating to the type of plug terminal 28 which is attached to it. As shown, the plug terminal 28 comprises an ID component 46 which is configured to provide an ID data item. Correspondingly, the plug body 26 comprises the ID reader 24 that is configured to read the ID data item provided by the ID component 46.

The ID component 46 and the ID reader 24 may be embodied in various ways. For example, it is envisaged that a visual approach would be acceptable in which the ID reader 24 takes the form of an imaging device which is positioned on the electrical appliance 2 to capture the ID data item on the plug terminal 28 when it is located on the plug body 26 or brought into proximity with it. Therefore, the ID data item may be a bar code of some type, for example a QR code which identifies the plug type of the plug terminal 28.

In another example, the ID component 46 may provide an ID data item in the form of an identifiable pattern or array of bumps, pips or protrusions on the surface of the plug terminal 28. In a complementary way, the ID reader 24 may take the form of a series of microswitches which are arranged in a matching pattern with the bumps such that the microswitches are able to detect which bumps are present and which are absent. A different configuration of bumps may be provided for each plug type, such that the microswitch array is able to detect the plug type attached.

Another option is for the ID component 46 to be a predetermined electrical component such as a resistor or capacitor, for example. In such a case, the electrical attribute of the component such as a resistance or capacitance value may be representative of the specific plug type. The ID reader 24 may be provided with suitable electrical contact pins in order to make contact with the ID component 46 and sense the electrical attribute and therefore identify the plug type. Instead of a predetermined resistance or capacitance, a further option would be to include a memory module (not shown) in the plug terminal 28 which is programmed with an appropriate ID data item. The ID reader 24 may therefore be configured to communicate with the memory module in order to determine the ID data item. The memory module may be any suitable memory, such as a non-volatile memory module which is able to retain its memory state without a power supply. An electrically-erasable programmable read-only memory (EEPROM) is one example of a suitable memory type, as would be apparent to the skilled person.

In the illustrated embodiment, the ID reader 24 is a RFID (Radio Frequency Identification) reader. Correspondingly the ID component 46 is a RFID transponder, more commonly known as a RFID tag, and will be referred to as such from now on. Together, the ID reader 24 and the RFID tag constitute an RFID system of the electrical appliance 2.

The RFID tag 46 is suitably configured to encode an identification number, code or other suitable indication into an internal memory module which can be read by the ID reader 24. The ID data item may take different forms. The data item may be encoded with a specific identification number that is determined by the manufacturer of the electronic appliance 2 in order suitably to identify the specific plug terminal that is being used, thereby being able to determine which settings need to be applied to the appliance. Optionally, the data item may encode a code that is in conformance with the Electronic Product Code (EPC) system of unique product identifiers, and as governed by the EPCGlobal Tag data standard. Here, the term RFID is used as a broad term to refer to Radio Frequency Identification, although it should be understood as covering a range of contactless communication approaches such as NFC and Bluetooth (both of which are suitably acknowledged as trade marks).

The RFID tag 46 may be passive or active, in accordance with known RFID technology. Currently, it is envisaged that the transmission distances over which the RFID transponder is required to act will be small such that a passive transponder will provide sufficient range. Similarly, it is envisaged that a relatively low frequency transponder will be sufficient, in the range of approximately 120 kHz-150 kHz. Using a passive transponder means that the system is simplified because it has a lower power requirement and does not require a separate power source, as would be the case in an active transponder. However, simply because a passive transponder has certain advantages in simplicity and cost, does not mean that the invention is excluded from using an active transponder if the application is suited to it. In either case, an advantage is that the ID reader is able to read the ID component in a contactless manner and with proven technology.

Optionally, the transmission of the ID data item will only take place when the plug terminal 28 is brought into contact with the plug body 26 or when it is situated in proximity. In this way, cross talk or interference with other plug terminals may be avoided. Optionally, suitable detection functionality may be provided in the RFID reader 24 to issue an interrogation signal when the plug terminal 28 is connected to the plug body 26. This may be achieved by the plug control module 22 having suitable software functionality to detect when the circuit is completed with the plug terminal 28 attached.

In the illustrated embodiment, the ID reader 24 has been shown as being implemented on the plug body 26 and the RFID tag 46 is implemented on the plug terminal 28. However, it should be noted at this point that this is not essential and the ID reader 24 may be implemented on other parts of the electrical appliance.

As has been discussed above, the electrical appliance 2 is configured to configure itself appropriately based on the type of plug terminal 28 that it detects as being connected to the plug body 26. In the specific context of a hair dryer, as shown in FIG. 2, the electrical appliance 2 may therefore be configured to adjust the power draw of the fan unit 18 and/or the power draw of the heater unit 20.

As a further example of this, standard settings of the electrical appliance may be when a UK plug type is attached to the plug body 26. In this case, the ID reader 24 is configured to read the ID data item on the RFID tag 46 on the plug terminal 28 and determine the ID data item associated with the plug terminal 28. As has been discussed, the ID data item may be a manufacturer-defined value, or it may indicate a specific plug type, e.g. that the plug type is a UK plug type. The plug control module 22 communicates with the ID reader 24 to obtain the ID data item and then communicates with the appliance control module 16 by way of the electrical cable 6.

On receipt of the ID data item, the appliance control module 16 then configures the power supply to the fan unit 18 and the heater unit 20 appropriately. The attribute configuration that may be applied in dependence on the ID data item is exemplified below:

TABLE 1

| | | Supply | Motor | Heater |
|---|---|---|---|---|
| Plug ID/Plug type | Country | voltage | power | power |
| 1/Type G | UK | 230 V | 120 W | 1400 W |
| 2/Type D | India | 230 V | 110 W | 1300 W |
| 3/Type A | USA | 120 V | 120 W | 1400 W |
| 4/Type A | Japan | 110 V | 100 W | 1200 W |

It should be noted that US and Japan may use the same plug type but have different device power requirements, as will be appreciated from reviewing Table 1. So, it is not envisaged that the ID data item will indicate the plug type directly, but rather a specific identifier such as an integer number which can be crossed referenced by the appliance control module 16.

In the above table, it should be appreciated that the motor power attribute and the heater power attribute indicate the maximum power levels that may be applied. It will be appreciated that the device may be operable at multiple different power levels, so the attributed effectively provide an upper limit to the power draw. The skilled reader will appreciate that this may be achieved in different ways, however. For example, the control system may be configured to limit the maximum current flowing to the motor unit 18 or the heater unit 20 for a given voltage level.

In a further enhancement of the above system and its associated functionality, the control system may be configured to detect a variety of operational parameters to ensure correct and safe operation. For example, the control system may be configured to monitor the power supply to which it is connected and to verify that the power supply corresponds to what is expected based on the attribute settings the appliance has applied. In the illustrated example of a hair dryer, this ensures that the power draw settings of the heater unit 18 and the fan unit 20 match the applied voltage and frequency of the domestic power supply to which the appliance is connected. If a mismatch is detected, appropriate action can be taken to notify the user that there is a problem and e.g. that the plug terminal should be changed.

In another example, appropriate temperature sensing means may be provided in the plug body 26, as indicated by the sensor 25. Therefore, in addition to setting selected electrical attributes for the electrical appliance in dependence on the ID data item, and, optionally, verifying that the power supply voltage and frequency are as expected, the control system can perform a further check to ensure that the temperature of the plug body, and/or the pins on the plug terminal, are within range.

If the sensed temperature goes out of range, then an appropriate safety response action can be taken, which may include reducing power consumption of the electrical appliance or triggering a shut down. This provides a further protective measure to ensure that the current rating of the plug 10 and the mains socket to which it is connected is not exceeded

Some variants on the illustrated embodiments have already been described above. However, the skilled person would understand that other modifications may be made to those specific examples without departing from the inventive concept, as defined by the claims.

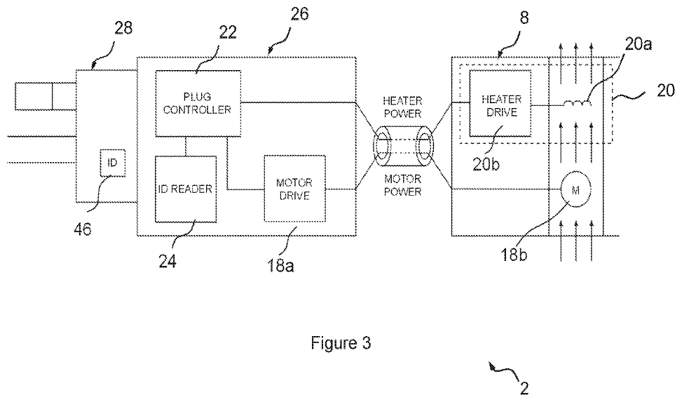

One such example is shown in FIG. 3, which is similar to FIG. 2 so only the differences will be explained here, for brevity. Further, parts in common to FIG. 2 are referred to using the same reference numerals.

In this example of the invention, a greater degree of functionality of the electrical appliance 2 is contained within the plug body 26 as compared to the main body 8 compared with the example of FIG. 2. It will be appreciated that the main body 8 still contains the heater unit 20, shown here as comprising a heater element 20a and a driver module 20b. However, other functional components are located in the plug body 26. As such, the plug body 26 comprises the plug controller 22, the ID reader 24 and also a motor driver module 18a, which is operatively connect to the motor 18b, such that the motor drive module 18a and the motor 18b together constitute the motor unit 18 of the appliance 2.

Therefore, in this example the plug controller 22 is suitably configured and programmed to provide all power supply requirements for the electrical appliance 2 and also all the functionality relating to the ID card reader 24 and the ID component 46 located on the plug terminal 28.

In another example, not shown here, the functionality of the body controller and the plug controller may be provided in the main body rather than on the plug body. In this example, therefore, suitable electrical wiring having power and communications functionality may be provided in the cable connecting the plug body and the main body to communicate by an appropriate means with an ID tag provided on the plug terminal. As before, the communication may be achieved wirelessly, or through some form of direct electrical contact between the ID component and a suitable interface on the plug body.

In other examples, appropriate circuit breaker functionality may be integrated into the appliance. An example of this is what is conventionally known as a Appliance Leakage Current Interrupter (ALCI) that is typical in appliances sold in the US market. The ALCI circuitry may be made to be part of the plug terminal 28 that is removable from the plug body 26. This would mean that the ALCI circuitry is only included in plug terminals that are associated with geographical regions that mandate the use of such circuitry for high power appliances. Other configurations would be acceptable.

In the illustrated examples described above, the plug terminal is removable from the plug body. However, examples are also envisaged that the plug terminal is not removable from the plug body. That is, the pins of the plug are provided from the plug body rather than being provided on a removable component. This may be useful where a single product is used for multiple different countries. By way of explanation, this embodiment of the invention would enable a product to be built for multiple different countries as a single stock keeping unit (SKU) which could then be fitted with an e.g. moulded plug specific to the territory in which it is destined for use. The existence of the ID component in the plug, which is able to communicate with the ID reader on the main body, means that the main body of the appliance is able to configure its internal power settings as appropriate. Beneficially, therefore, the completed product would not need to be reprogrammed for specific regions which would reduce manufacturing complexity, and therefore cost.

1. An electrical appliance comprising:
an electrical plug comprising an ID component configured to provide an ID data item;
wherein the appliance comprises a control system comprising an ID reader configured to read the ID component, wherein the control system is operable to configure at least one operational attribute of at least one electrical device of the electrical appliance in dependence on the ID data item.

2. The electrical appliance of claim 1, wherein the ID data item is indicative of a country-suitability of a plug terminal.

3. The electrical appliance of claim 1, wherein the electrical plug comprises a plug body and a removable plug terminal.

4. The electrical appliance of claim 3, wherein the ID reader is located at the plug body.

5. The electrical appliance of claim 3, wherein the plug body is connected at the tail of an electrical cable extending from a body of the electrical appliance.

6. The electrical appliance of claim 1, wherein the ID component is a data processing component which is configured to transmit the ID data item to the ID reader.

7. The electrical appliance of claim 1, wherein the ID reader comprises an RFID receiver and wherein the ID component is an RFID transponder configured to transmit the ID data item to the ID reader.

8. The electrical appliance of claim 1, wherein the ID reader is an optical sensor and wherein the ID data component is a visual marker configured to be read by the ID reader.

9. The electrical appliance of claim 1, wherein the at least one operational attribute includes: i) a maximum voltage value, ii) a maximum current value, and iii) a maximum power value of the at least one electrical device.

10. The electrical appliance of claim 1, wherein the at least one electrical device includes a heater unit.

11. The electrical appliance of claim 1, wherein the at least one electrical device includes a fan unit.

12. The electrical appliance of claim 3, preceding claims, further including a sensor integrated into the plug body to sense at least one operational parameter.

13. The electrical appliance of claim 12, wherein the control system is configured to trigger a response action based on the sensed operational parameter.

14. The electrical appliance of claim 13, wherein the sensor is a temperature sensor.
